(19) United States
(12) Patent Application Publication
(10) Pub. No.: US 2008/0317642 A1
(43) Pub. Date: Dec. 25, 2008

(54) Batch Contaminated Resource Treatment Method and Apparatus

(76) Inventors: Eugene A. Moskal, Kelowna (CA); H. Willard Spencer, III, Vancouver, WA (US)

Correspondence Address: VENABLE, CAMPILLO, LOGAN & MEANEY, P.C., 1938 E. OSBORN RD, PHOENIX, AZ, 85016-7234, US

(21) Appl. No.: 10/595,295

(22) PCT Filed: Oct. 7, 2004
(86) PCT No.: PCT/US04/33109

§ 371 Date: Apr. 5, 2006

Related U.S. Application Data
(60) Provisional application No. 60/509,697, filed on Oct. 7, 2003.
(60) Provisional application No. 60/509,698, filed on Oct. 7, 2003.

(51) Int. Cl. C02F 1/36; B06B 1/20

(52) U.S. Cl. 422/128; 210/748

(57) ABSTRACT

This invention provides methods and apparatus for treating a batch contaminated resource using an ultrasonic pressure wave. A method of treating a batch contaminated resource is described comprising the steps of introducing at least one oxidizing agent into the batch contaminated resource; and energizing the batch contaminated resource and the at least one oxidizing agent with an ultrasonic pressure wave; and an apparatus is described for treating a batch contaminated resource using at least one transducer (300) in a transducer housing (320) to produce ultrasonic pressure waves in the batch contaminate resource wherein the transducer housing is inside a container (200) and an energy source for energizing the at least one transducer is coupled to the at least one transducer (300).

### BACKGROUND OF THE INVENTION

1. Field of the Invention

The present invention relates to the field of contaminated resource treatment, and more particularly to the oxidation of contaminants in a batch contaminated resource. This application claims priority of United States Provisional Patent Application Nos. 60/509,698 and 60/509,697 which are both hereby incorporated by reference into this application.

2. Discussion of Related Art

The quantity of contaminants produced by industrial and household activity continues to grow. Additionally, the responsibility to properly dispose of and remediate contaminated resources containing natural and man-made solids increase as new and more stringent environmental standards are introduced. For example, companies and municipalities are increasingly charged with the responsible treatment and disposal of their waste containing solids. As a result, contaminated resource treatment has emerged as a fundamental concern.

Organic hydrocarbons are a primary contaminant of liquids and solids and therefore a primary concern addressed during solid waste treatment. Organic hydrocarbon contaminants are generally associated with the production of oil or oil-based solvents and often reach solids by accidents (industrial or otherwise), household use, evaporation and condensation. Carbon-based chemicals are suspected carcinogens and also of concern because of the ready absorption and metabolism by humans and animals.

Metals have many sources that create hazardous waste and may, for example, contaminate solids through the water supply. Metals such as cadmium and lead have profound adverse effects on humans, animals, and plant life. Disposed of oils often carry metals as a result of lubrication use within metal engines. Oils also used as coolants in manufacturing or repair, or as solvents in the electronics industry are also sources of heavy metal contamination.

Another contaminant of solids may be microorganisms such as E. coli, amoebas, cryptosporidium, cholera, viruses, and bacteria. Chlorine and chloramine treatment are current conventional water treatments. However, depending upon the conditions, chlorine could possibly react with the organic material to produce chlorinated hydrocarbons.

Treatment methods for water and solids have evolved to deal with the above problems. Related art apparatuses have utilized oxidation systems to oxidize metal and hydrocarbon contaminants to acceptable discharge levels and drinking water standards. Oxidation also destroys the cellular walls of microorganisms that may then dissipate harmlessly into the water. Oxidation is often catalyzed with heat energy. The rapid oxidation of organic or metals species in air results in carbon dioxide and water with organics or a metal oxide or “natural ore” with metals. However, while heat energy is one means of facilitating the oxidation of waste contaminants, alternative means have become more preferred for various reasons particularly related to safety.

At least one related art disclosure has implemented apparatuses to facilitate the breakdown and oxidation of contaminants in wastewater. U.S. Pat. No. 4,003,832 issued to Henderson et al., discloses the use of a sonication-ozonation tower to facilitate the oxidation of pre-filtered wastewater. Other related art methods and apparatuses use sonic radiation to further facilitate the oxidation process by reducing the size of the contaminants to a size more readily suitable for oxidation.

Exemplary methods and apparatuses to facilitate the breakdown of contaminants in waste water include: U.S. Pat. No. 5,895,577, which employs a sonication tank to disintegrate microbial sludge; U.S. Pat. Nos. 2,138,839 & 2,417,722, which uses sonic energy to treat consumable liquids; U.S. Pat. No 5,380,445, which is used to rupture the cell walls of biological microorganisms; U.S. Pat. No. 6,019,947, which uses dynamic cavitation to sheer coagulants and sludge and bacteria from waste water. Other methods and apparatuses for removing contaminates include related U.S. Pat. No. 6,630,073 (U.S. patent application Ser. No. 09/942,471) and U.S. Pat. No. 4,537,599 for processing and removing sulfur and ash from coal. U.S. Pat. No. 6,630,073 is hereby incorporated by reference into this application.

While the above-discussed apparatuses prove useful for water treatment, additional improvements in apparatuses and increased efficiencies are needed for exploitation in the waste treatment industry and especially waste treatment in-situ.

### SUMMARY OF THE INVENTION

While the above methods and apparatuses of contaminant breakdown and oxidation are desirable, the method of the present invention, Batch Solid Sonic Oxidation (BSSO) provides increased efficiency in the oxidation of contaminants in a solid contaminated resource. As a result, fewer contaminants and fewer intermediate products escape the oxidation reaction. Moreover, oxygen requirements are minimized due to the increased efficiency and nature in which the contaminate molecules are processed in batch until the oxidation reactions carry out to completion. Thus, BSSO provides a convenient way of processing the solid contaminants.

Specifically, this invention provides methods and apparatus for treating a batch contaminated resource using an ultrasonic pressure wave. The batch contaminated resource contains contaminates (for example a batch contaminated resource may range in conditions between wet and dry such as a dry contaminated resource, a semi-dry contaminated resource, a solid-liquid combination contaminated resource and a wet contaminated resource) having a boundary that occurs where contaminates of interest decrease to acceptable levels and/or where a man-made boundary exists. Preferably, the batch contaminated resource has a volume contained within the boundary. Acceptable levels of contaminates are typically contaminate levels regulated by the government, levels regulated by industry, levels regulated by a company or individual, and levels where further treatment would not achieve substantial contaminate reduction. Preferred examples of batch contaminated resources include, but are not limited to contaminated earth or ground in a dry or mud-like state and contaminated waste products in a dry, semi-dry or sludge-like state.

In one aspect of the invention, a method of treating a batch contaminated resource is described comprising the steps of introducing at least one oxidizing agent into the batch contaminated resource; and energizing the batch contaminated resource and the at least one oxidizing agent with an ultrasonic pressure wave.

In another aspect of the invention, an apparatus is described for treating a batch contaminated resource using at least one transducer in a transducer housing to produce ultrasonic pressure waves in the batch contaminated resource wherein the transducer housing is inside a container and an energy source for energizing the at least one transducer is coupled to the at least one transducer.

### BRIEF DESCRIPTION OF THE DRAWINGS

FIG. 1 depicts a side view of a first preferred embodiment of treating a batch contaminated resource;

FIG. 2 depicts a side view of a first preferred embodiment of an apparatus for treating batch contaminated resources.

FIG. 3 depicts a side view of a first preferred embodiment of a transducer and a transducer housing;

FIG. 4 depicts a side view of a second preferred embodiment of an apparatus for treating batch contaminated resources;

FIG. 5 depicts a side view of a second preferred embodiment of treating a batch contaminated resource; and

FIG. 6 depicts a cross-sectional view of a preferred embodiment of the invention diagramatically showing ultrasonic pressure waves between multiple apparatus for treating batch contaminated resources.

### DETAILED DESCRIPTION OF THE EMBODIMENT

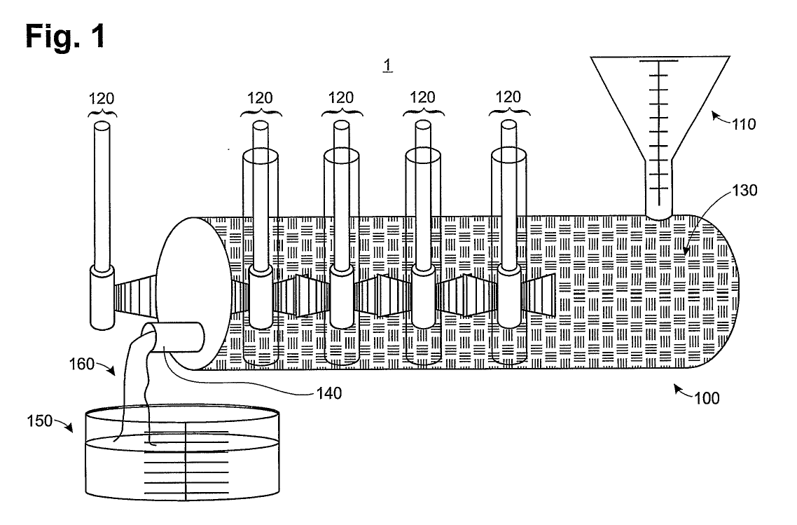

The invention as summarized above can be implemented in several alternate embodiments. One embodiment of the invention may be implemented in an exemplary first batch contaminated resource treatment apparatus 1. The batch contaminated resource treatment apparatus 1 is depicted in FIG. 1. However, the exemplary first batch contaminated resource treatment apparatus 1 implementing the invention is for explanation purposes and not intended to limit the scope of the invention. An ordinarily skilled practitioner in the art could modify the disclosure herein to manifest alternate embodiments employing the method and the apparatuses of the invention.

The exemplary first batch contaminated resource treatment apparatus 1 preferably include components such as a vessel 100 to contain the batch contaminated resource 130, an oxidizing agent delivery apparatus 110, and at least one apparatus for treating a batch contaminated resource 120 to energize the oxidizing agent. Preferably, the exemplary first batch contaminated resource treatment apparatus 1 may include a pressure reducing device 140 (preferably a drain spout or a pump) and a retention device 150. While additional oxidizing agents are contemplated to also be useful, preferred oxidizing agents may be supplied or generated in an ordinary way such as by an H₂O₂ tank (not shown), an H₂O₂Pump (not shown) and an air pump (not shown) together with an ultra-violet array (not shown). Thereafter, the oxidizing agents and the batch contaminated resource are combined in the vessel 100 where the oxidizing agent and the batch contaminated resource are intimately commingled. In a preferred embodiment, at least one binding agent may be added to the batch contaminated resource to enhance the treatment of the batch contaminated resource. Preferable examples include, but are not limited to, premixing at least one binding agent with the batch contaminated resource and/or layering at least one binding agent with the contaminated resource. Examples of binding agents are contemplated to include engineered clays, diatomaceous earth, fullerenes, bucky balls, nanotubular forms, and natural and synthetic engineered zeolites.

In the exemplary first batch contaminated resource treatment apparatus 1, the vessel 100 contains the batch contaminated resource 130 (preferably in a packed bed) and may or may not contain at least one of the exemplary binding agents (not shown). In a preferred embodiment the vessel 100 may further comprise additional vessels or zones of glass, silica, and charcoal, which each provide reaction sites for oxidizing reactions of the waste-water contaminant having different properties.

In this first preferred embodiment of the invention, the oxidizing agent is introduced to the batch contaminated resource as a liquid. Preferably, the oxidizing agent is in an aqueous solution. The first batch contaminated resource treatment apparatus 1 facilitates the oxidation of the contaminants within the batch contaminated resource using the transducers to produce ultrasonic pressure waves to energize and extend the life of the oxidizing agents flowing in an aqueous solution through the batch contaminated resource (such as atomic oxygen and hydroxyl radicals that, for example, can be generated by a UV array, not shown).

After the aqueous solution has flowed through the batch contaminated resource 130 in the vessel 100 to form a oxidizing agent effluent 160, the oxidizing agent effluent 160 may be transferred by a pressure reducing device 140 by gravity though a drain spout or by other means such as a pump to a retention device 150. The illustrated order of the first batch contaminated resource treatment apparatus 1 components is preferred, however, the actual order of the first batch contaminated resource treatment apparatus 1 components can be varied to a reasonable extent as would be obvious to one of ordinary skill in the art.

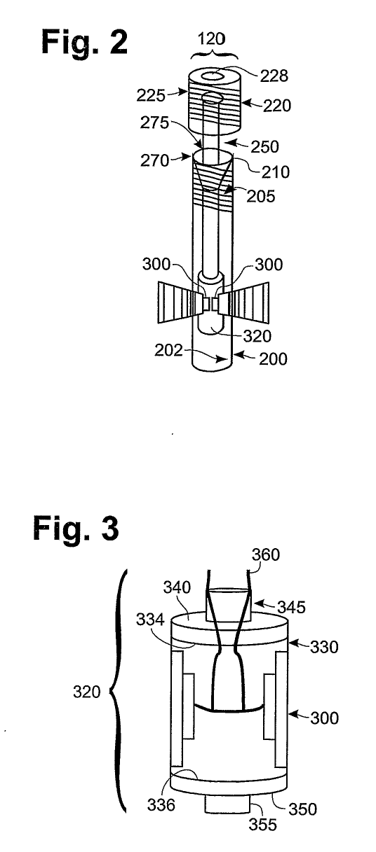

FIG. 2 is a side view of a preferred embodiment of an apparatus for treating a batch contaminated resource 120 (sometimes known as a pieozometer). The apparatus for treating a batch contaminated resource 120 comprises a container 200 having an inside 202 and a transducer 300. In the preferred embodiment of FIG. 2, the apparatus for treating a batch contaminated resource 120 comprises a container 200 having an open end 210, a cap 220, a transducer 300 in a transducer housing 320, a transducer shaft 250, and a sealing device 270. Preferably the cap 220 is couplable to the container 200 at the container's open end 210. Most preferably, the cap 220 comprises internal threads 225 and the container comprises external threads 205 that couple with the internal threads 225 of the cap 220. In the preferred embodiment of FIG. 2, the cap 220 also comprises a cap opening 228. In the preferred embodiment of FIG. 2, the cap opening 228 is of sufficient size to allow the transducer shaft 250 to pass through the cap opening. The preferred embodiment in FIG. 2 also comprises a sealing device 270, and more preferably the sealing device 270 having an sealing device opening 275 of sufficient size to allow the transducer shaft 250 to pass through the sealing device opening. In the preferred embodiment, the sealing device produces a liquid resistant seal. In a more preferred embodiment, the sealing device 270 is a stopper that can produce the liquid resistant seal between the transducer shaft and the sealing device and between the cap and the cylinder; for example in a most preferred embodiment, the stopper is distorted to create the seal when the cap is screwed onto the container. In this preferred embodiment, the transducer 300 may be positioned in along the axis of the container.

FIG. 3 is a side view of a preferred embodiment of the at least one transducer 300 and transducer housing 320. In the preferred embodiment of FIG. 3, the transducer housing 320 may be of any material that is compatible with the at least one transducer 300. In this preferred embodiment by way of example only, two transducers are placed in a cylindrical transducer housing to produce ultrasonic pressure waves in two directions. However, it will be obvious to one of ordinary skill in the art that the number and geometry of the transducers and the transducer housing will affect the amount and direction of the ultrasonic pressure waves. (preferably such as ultrasonic pressure waves produced primarily uni-directional or multi-directional). For example, in the preferred embodiment of FIG. 3 the transducers can be placed radially as required for uni- or multi-directional emissions of ultrasonic pressure waves. In the preferred embodiment of FIG. 3, the transducer housing 320 is comprised of a body 330 having a body first open end 334 and a body second open end 336; a top 340 having top bosses 345; a bottom 350 having bottom bosses 355 and electrical connecting devices 360 (such as wires; coaxial cable; etc.). In the preferred embodiment of FIG. 3, the electrical connecting devices are coupled to the at least one transducer 300 and an energy source (not shown) for energizing the at least one transducer. FIG. 3 also shows a preferred embodiment where the top plate 340 and the bottom plate 350 are adapted to couple to the cylindrical body 330. Most preferably, the top plate 340 and the bottom plate 350 are threaded in a manner to adaptively couple to the cylindrical body 330 having threads at the first open end 334 and threads at the second open end 336. Most preferably, the transducer housing 320 is fashioned from stainless steel.

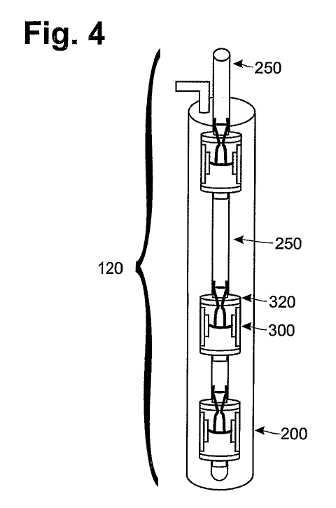

FIG. 4 is a side view of a preferred embodiment of showing multiple transducer housings 320. The preferred embodiment of FIG. 4, shows that the number, direction and position along the container axis of the at least one transducer may be varied. Most preferably, the position of the transducers and type of transducers (such as unidirectional emissions or multi-directional emissions) may be changed by using varying lengths of transducer shafts that are adapted to couple the transducer housings.

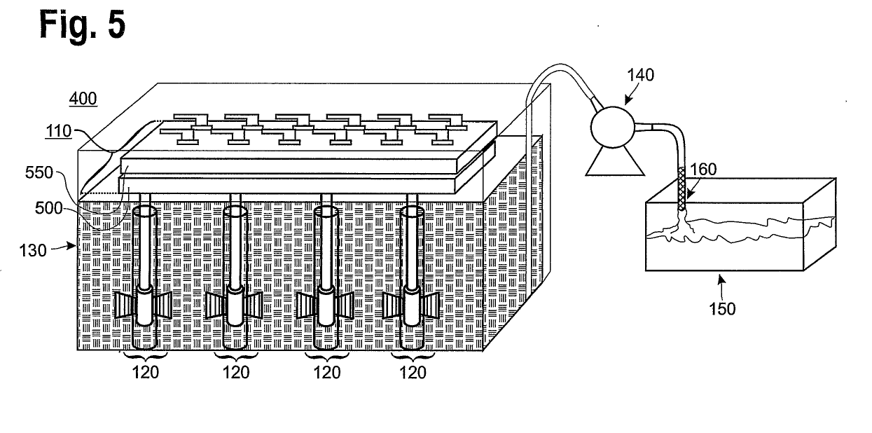

FIG. 5 is a side view of an exemplary second batch contaminated resource treatment apparatus 400. The exemplary second batch contaminated resource treatment apparatus 400 preferably includes an oxidizing agent delivery apparatus 110, and at least apparatus for treating a batch contaminated resource 120 to energize the oxidizing agent. While FIGS. 1 and 5 include a vessel 100 to create a man-made boundary, it is to be understood by one of ordinary skill in the art that the exemplary first and second batch contaminated resource treatment apparatus do not necessarily require a vessel and may be applied to a batch contaminated resource in-situ. However, the exemplary second batch contaminated resource treatment apparatus 400 implementing the invention is for explanation purposes and not intended to limit the scope of the invention. An ordinarily skilled practitioner in the art could modify the disclosure herein to manifest alternate embodiments employing the method and the apparatuses of the invention.

Preferably, the at least one transducer 300 will be placed adjacent to the batch contaminated resource boundary such that the at least one transducer. More preferably, the at least one transducer 300 will be placed outside, at or inside the boundary. Most preferably, the at least one transducer 300 is within the volume of the batch contaminated resource.

In the exemplary second batch contaminated resource treatment apparatus 400, the oxidizing agent delivery apparatus 110 preferably comprises an impermeable material 550 (such as tank farm liner) and a semi-permeable material 500 (such as geotextile having wicking characteristics) adjacent to at least part of the boundary of the batch contaminated resource and an impermeable material 550. More preferably, the semi-permeable material 500 is at or outside the boundary. Most preferably, the boundary is the ground or other in-situ surface and the semi-permeable material 500 is at or outside the boundary. In this second preferred embodiment, the oxidizing agent is introduced to the semi-permeable material 500, and more preferably is introduced through the impermeable material. In an alternative embodiment not shown, the oxidizing agent may be injected in to the batch contaminated resource 130.

Preferably, the exemplary second batch contaminated resource treatment apparatus 400 may also include a pressure reducing device 140 (preferably a pump) and a retention device 150. Thereafter, the oxidizing agents and the batch contaminated resource 130 are combined where the oxidizing agent and the batch contaminated resource 130 are intimately commingled. In the second preferred embodiment, at least one binding agent may also be added to the batch contaminated resource 130 to enhance the treatment of the batch contaminated resource 130. Preferable examples include, but are not limited to, premixing at least one binding agent with the batch contaminated resource 130 and/or layering at least one binding agent with the batch contaminated resource 130. More preferably, the at least one binding agent may be layered or mixed in a manner to enhance the oxidation of contaminates according to boundary and/or oxidizing agent movement in the batch contaminated resource 130. Most preferably, the at least one binding agent is layered or mixed in a manner to enhance the oxidation of contaminates according to boundary and/or oxidizing agent movement when the batch contaminated resource 130 is in-situ. Examples of binding agents are contemplated to include engineered clays, diatomaceous earth, fullerenes, bucky balls, nanotubular forms, and natural and synthetic engineered zeolites.

In this second preferred embodiment of the invention, the oxidizing agent is introduced to the batch contaminated resource 130 as a liquid. Preferably, the oxidizing agent is in an aqueous solution. The second batch contaminated resource treatment apparatus 400 facilitates the oxidation of the contaminants within the batch contaminated resource 130 using the at least one apparatus for treating a batch contaminated resource 120 to produce ultrasonic pressure waves to energize and extend the life of the oxidizing agents in an aqueous solution permeating the batch contaminated resource (such as atomic oxygen and hydroxyl radicals that, for example, can be generated by a UV array, not shown).

In a most preferred embodiment, the aqueous solution flows through the batch contaminated resource 130 to form a oxidizing agent effluent 160, the oxidizing agent effluent 160 may be transferred by a pressure reducing device 140 such as a pump or by other means such as permeation to a retention device 150 or retention basin (not shown). The illustrated order of the second batch contaminated resource treatment apparatus 400 components is preferred, however, the actual order of the second batch contaminated resource treatment apparatus 400 components can be varied to a reasonable extent as would be obvious to one of ordinary skill in the art.

In a third preferred embodiment of this invention (not shown), the oxidation of contaminants in a batch contaminated resource occurs in a manner similar to second preferred embodiment, except that the batch contaminated resource is in-situ. More preferably, the batch contaminated resource of the third preferred embodiment is an in-situ batch contaminated resource such as contaminated earth or ground. Most preferably, the batch contaminated resource of the third preferred embodiment is an in-situ batch contaminated resource and does not have a man-made boundary. For example, contamination of the ground or earth occurs in various manners such as natural and man-made pollutants. One non-limiting example of a contamination that creates the in-situ batch contaminated resource is the spilling or improper disposal of man-made organic hydrocarbons such as gasoline or oil. However, the exemplary third batch contaminated resource treatment implementing the invention is for explanation purposes and not intended to limit the scope of the invention. An ordinarily skilled practitioner in the art could modify the disclosure herein to manifest alternate embodiments employing the method and the apparatuses of the invention.

The exemplary third batch contaminated resource treatment preferably includes, an oxidizing agent delivery apparatus (for example see 110 FIG. 5), and at least apparatus for treating a batch contaminated resource to energize the oxidizing agent (for example see 120 FIG. 5). Preferably, the at least one transducer will be placed adjacent to the batch contaminated resource boundary (for example see 300 FIG. 5). More preferably, the at least one transducer will be placed outside, at or inside the boundary. Most preferably, the at least one transducer is within the volume of the batch contaminated resource.

In the exemplary third batch contaminated resource treatment, the oxidizing agent delivery apparatus preferably comprises an impermeable material (such as tank farm liner) and a semi-permeable material (such as geotextile having wicking characteristics) adjacent to at least part of the boundary of the batch contaminated resource and an impermeable material (see for example 110, 550 and 500 of FIG. 5). Most preferably, the boundary is the ground or other in-situ surface and the semi-permeable material is at or outside the boundary. In this third preferred embodiment, the oxidizing agent is introduced to the semi-permeable material, and more preferably is introduced through the impermeable material. In an alternative embodiment not shown, the oxidizing agent may be injected in to the batch contaminated resource.

Preferably, the exemplary third embodiment of batch contaminated resource treatment may also include a pressure reducing and a retention device or retention basin (see for example 140 and 150 of FIG. 5). Thereafter, the oxidizing agents and the batch contaminated resource are combined where the oxidizing agent and the batch contaminated resource commingle. In this third preferred embodiment, at least one binding agent may also be added to the batch contaminated resource to enhance the treatment of the batch contaminated resource. Preferable examples include, but are not limited to, premixing at least one binding agent with the batch contaminated resource and/or layering at least one binding agent with the batch contaminated resource. More preferably, the at least one binding agent may be layered or mixed in a manner to enhance the oxidation of contaminates according to boundary and/or oxidizing agent movement in the batch contaminated resource. Most preferably, the at least one binding agent is layered or mixed in a manner to enhance the oxidation of contaminates according to boundary and/or oxidizing agent movement when the batch contaminated resource is in-situ. Examples of binding agents are contemplated to include engineered clays, diatomaceous earth, fullerenes, bucky balls, nanotubular forms, and natural and synthetic engineered zeolites.

In this third preferred embodiment of the invention, the oxidizing agent is introduced to the batch contaminated resource as a liquid. Preferably, the oxidizing agent is in an aqueous solution. The third embodiment of batch contaminated resource treatment facilitates the oxidation of the contaminants within the batch contaminated resource using the at least one apparatus for treating a batch contaminated resource to produce ultrasonic pressure waves to energize and extend the life of the oxidizing agents in an aqueous solution permeating the batch contaminated resource (such as atomic oxygen and hydroxyl radicals that, for example, can be generated by a UV array, not shown).

Most preferably for this third embodiment of the invention, the aqueous solution flows through the batch contaminated resource to form a oxidizing agent effluent, the oxidizing agent effluent may be transferred by a pressure reducing device such as a pump or by other means such as permeation to a retention device or retention basin (not shown). The described order of the third embodiment of the invention is preferred, however, the actual order of the third embodiment of the invention batch components can be varied to a reasonable extent as would be obvious to one of ordinary skill in the art.

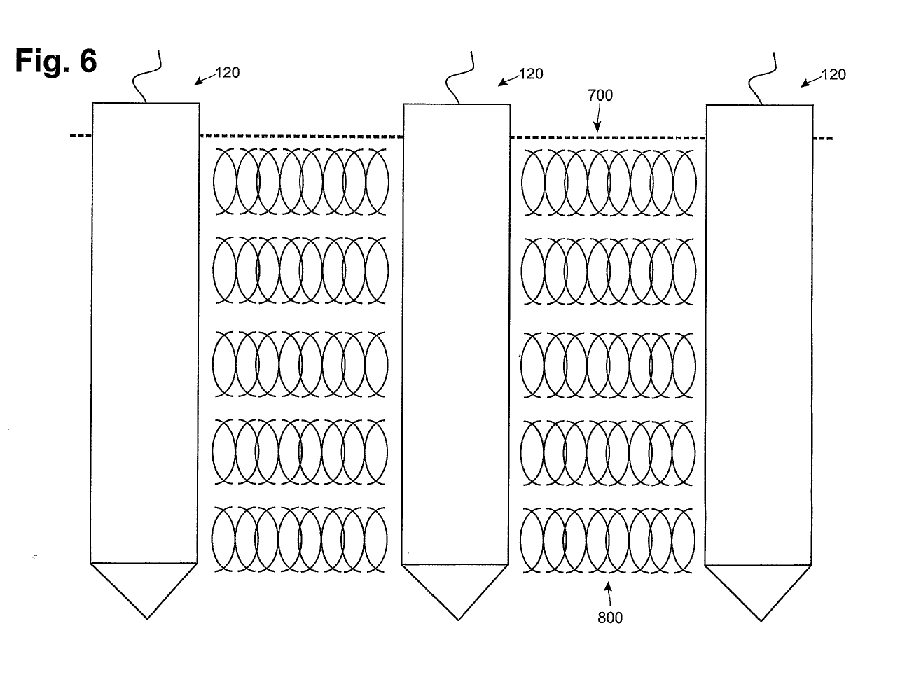

FIG. 6 depicts a cross-sectional view of a preferred embodiment of the invention diagramatically showing ultrasonic pressure waves between multiple apparatus for treating batch contaminated resources. The preferred embodiment of FIG. 6, depicts the boundary 700 of an in-situ batch contaminated resource and ultrasonic pressure waves 800 between multiple apparatus for treating batch contaminated resources. Most preferably, the boundary 700 is ground or earth. Preferably the ultrasonic pressure waves are sufficient to energize the oxidizing agent and the batch contaminated resource for treatment purposes. More preferably the transducers are positioned such that ultrasonic pressure waves may harmonically resonate.

The preferred embodiments are exemplary of a basic method of implementing the invention and are not intended to limit the scope of the invention. An ordinarily skilled practitioner in the art could modify the disclosure herein to manifest alternate embodiments employing the method and the apparatuses of the invention. Although particular embodiments of the invention have been described in detail, persons possessing ordinary skill in the art to which this invention pertains will appreciate that various modifications and enhancements may be made without departing from the spirit and scope of the invention examples that follow.

One example of the invention is a method of treating a batch contaminated resource comprising the steps of introducing at least one oxidizing agent into the batch contaminated resource and energizing the batch contaminated resource and the at least one oxidizing agent with an ultrasonic pressure wave. Preferably, the ultrasonic pressure wave for energizing the batch contaminated resource and the at least one oxidizing agent is created using at least one transducer. Preferably, the at least one oxidizing agent is introduced as a solution to the batch contaminated resource. Preferably, the solution is an aqueous solution. Preferably, the solution permeates the batch contaminated resource. Preferably, the solution flows through the batch contaminated resource. Preferably, this embodiment also comprises the step of removing the at least one oxidizing agent from the batch contaminated resource. More preferably, the at least one oxidizing agent is introduced as a solution to the batch contaminated resource and the solution is removed, and most preferably, the solution is aqueous. Preferably, the solution is removed using a pressure reducing device, and more preferably, the pressure reducing device is a pump. Preferably, the at least one oxidizing agent is selected from the group consisting of: ozone, hydrogen peroxide, and combinations thereof. Preferably, the batch contaminated resource has a boundary and wherein the step of energizing the batch contaminated resource and the at least one oxidizing agent comprises placing the at least one transducer adjacent to the boundary of the batch contaminated resource. Preferably, the batch contaminated resource has a boundary defining a volume and wherein the step of energizing the batch contaminated resource and the at least one oxidizing agent comprises placing the at least one transducer within the volume of the batch contaminated resource. Preferably, this embodiment of the invention also comprises using a binding agent.

A second example of the invention is a method to treat a batch contaminated resource comprising the step of arranging at least one transducer in a batch contaminated resource; introducing at least one oxidizing agent into the batch contaminated resource; and energizing the batch contaminated resource and the at least one oxidizing agent wherein the arranged at least one transducer can produce an ultrasonic pressure wave sufficient to energize the batch contaminated resource and the introduced at least one oxidizing agent. Preferably, arranging the at least one transducer creates a uni-directional ultrasonic pressure wave. Preferably, arranging the at least one transducer creates a multi-directional ultrasonic pressure wave. Preferably, arranging the at least one transducer includes producing a substantially uniform ultrasonic pressure wave in the batch contaminated resource. Preferably, arranging the at least one transducer includes placing the at least one transducer adjacent to a boundary of the batch contaminated resource. Preferably, arranging the at least one transducer includes placing the at least one transducer within the volume of the batch contaminated resource. Preferably, introducing at least one oxidizing agent into the batch contaminated resource comprises placing a semipermeable material having a first side adjacent to at least part of the batch contaminated resource boundary and a second side adjacent to an impermeable material through which the oxidizing agent is introduced. Preferably, this embodiment of the invention also comprises using a binding agent.

A third example of the invention is an apparatus for treating a batch contaminated resource comprising at least one transducer in a transducer housing and a container having an inside and outside wherein the transducer housing is inside the container; and an energy source coupled to the at least one transducer for energizing the at least one transducer for producing ultrasonic pressure waves in the batch contaminated resource. Preferably, the transducer housing further comprises a body having a body first open end and a body second open end; a top adaptively coupled to the body first open end, and a bottom adaptively coupled to the body second open end. Preferably, the at least one transducer housing is coupled to a transducer shaft for varying position the at least one transducer within the container. Preferably, the container comprises a cylinder having an open end and a cap for coupling to the open end; more preferably, the cap includes a cap opening sufficient to allow the transducer shaft to pass; and a sealing device for producing a liquid resistant seal, and most preferably, the sealing device is a stopper that can produce the liquid resistant seal between the transducer shaft and the sealing device and between the cap and the cylinder. Preferably, the invention may also comprise a semipermeable material having a first semipermeable side and a second semipermeable side; and an impermeable material; wherein the first semipermable side is placed adjacent to at least part of a batch contaminated resource boundary and the second semipermeable side is placed adjacent to the impermeable material. Most preferably, the impermeable material further comprises oxidizing agent introducing devices.

A fourth example of the invention is a method of treating a batch contaminated resource in-situ comprising the steps of introducing at least one oxidizing agent into the batch contaminated resource and energizing the batch contaminated resource and the at least one oxidizing agent with an ultrasonic pressure wave. Preferably, the ultrasonic pressure wave for energizing the batch contaminated resource and the at least one oxidizing agent is created using at least one transducer. Preferably, the at least one oxidizing agent is introduced as a solution to the batch contaminated resource. Preferably, the solution is an aqueous solution. Preferably, the solution permeates the batch contaminated resource. Preferably, the solution flows through the batch contaminated resource. Preferably, this embodiment also comprises the step of removing the at least one oxidizing agent from the batch contaminated resource. More preferably, the at least one oxidizing agent is introduced as a solution to the batch contaminated resource and the solution is removed, and most preferably, the solution is aqueous. Preferably, the solution is removed using a pressure reducing device, and more preferably, the pressure reducing device is a pump. Preferably, the at least one oxidizing agent is selected from the group consisting of: ozone, hydrogen peroxide, and combinations thereof. Preferably, the batch contaminated resource has a boundary and wherein the step of energizing the batch contaminated resource and the at least one oxidizing agent comprises placing the at least one transducer adjacent to the boundary of the batch contaminated resource. Preferably, the batch contaminated resource has a boundary defining a volume and wherein the step of energizing the batch contaminated resource and the at least one oxidizing agent comprises placing the at least one transducer within the volume of the batch contaminated resource. Preferably, this embodiment of the invention also comprises using a binding agent.

A fifth example of the invention is a method to treat a batch contaminated resource comprising in-situ the step of arranging at least one transducer in a batch contaminated resource; introducing at least one oxidizing agent into the batch contaminated resource; and energizing the batch contaminated resource and the at least one oxidizing agent wherein the arranged at least one transducer can produce an ultrasonic pressure wave sufficient to energize the batch contaminated resource and the introduced at least one oxidizing agent. Preferably, arranging the at least one transducer creates a uni-directional ultrasonic pressure wave. Preferably, arranging the at least one transducer creates a multi-directional ultrasonic pressure wave. Preferably, arranging the at least one transducer includes producing a substantially uniform ultrasonic pressure wave in the batch contaminated resource. Preferably, arranging the at least one transducer includes placing the at least one transducer adjacent to a boundary of the batch contaminated resource. Preferably, arranging the at least one transducer includes placing the at least one transducer within the volume of the batch contaminated resource. Preferably, introducing at least one oxidizing agent into the batch contaminated resource comprises placing a semipermeable material having a first side adjacent to at least part of the batch contaminated resource boundary and a second side adjacent to an impermeable material through which the oxidizing agent is introduced. Preferably, this embodiment of the invention also comprises using a binding agent.

What is claimed is:

1. A method of treating a batch contaminated resource comprising the steps of:
introducing at least one oxidizing agent into the batch contaminated resource; and
energizing the batch contaminated resource and the at least one oxidizing agent with an ultrasonic pressure wave.

2. The method of claim 1 wherein
the ultrasonic pressure wave for energizing the batch contaminated resource and the at least one oxidizing agent comprises at least one transducer.

3. The method of claim 1 wherein
the at least one oxidizing agent is introduced as a solution to the batch contaminated resource.

4. The method of claim 3 wherein
the solution is an aqueous solution.

5. The method of claim 3 wherein
the solution permeates the batch contaminated resource.

6. The method of claim 5 wherein
The solution flows through the batch contaminated resource.

7. The method of claim 1 further comprising
removing the at least one oxidizing agent from the batch contaminated resource after treatment.

8. The method of claim 7 wherein
the at least one oxidizing agent is introduced as a solution to the batch contaminated resource and the solution is removed after treatment.

9. The method of claim 8 wherein the solution is aqueous.

10. The method of claim 8 wherein the solution is removed using a pressure reducing device.

11. The method of claim 10 wherein the pressure reducing device is a pump.

12. The method of claim 1 wherein the at least one oxidizing agent is selected from the group consisting of: ozone, hydrogen peroxide, and combinations thereof.

13. The method of claim 2 wherein the batch contaminated resource has a boundary and wherein the step of energizing the batch contaminated resource and the at least one oxidizing agent comprises
placing the at least one transducer adjacent to the boundary of the batch contaminated resource.

14. The method of claim 2 wherein the batch contaminated resource has a boundary defining a volume and wherein the step of energizing the batch contaminated resource and the at least one oxidizing agent comprises
placing the at least one transducer within the volume of the batch contaminated resource.

15. A method to treat a batch contaminated resource comprising the step of:
arranging at least one transducer in a batch contaminated resource;
introducing at least one oxidizing agent into the batch contaminated resource; and
energizing the batch contaminated resource and the at least one oxidizing agent;
wherein the arranged at least one transducer can produce an ultrasonic pressure wave sufficient to energize the batch contaminated resource and the introduced at least one oxidizing agent.

16. The method of claim 15 wherein the step of
arranging the at least one transducer creates a uni-directional ultrasonic pressure wave.

17. The method of claim 15 wherein the step of
arranging the at least one transducer creates a multi-directional ultrasonic pressure wave.

18. The method of claim 15 wherein the step of
arranging the at least one transducer comprises producing a substantially uniform ultrasonic pressure wave in the batch contaminated resource.

19. The method of claim 15 wherein the step of
arranging the at least one transducer includes placing the at least one transducer adjacent to a boundary of the batch contaminated resource.

20. The method of claim 15 wherein the step of
arranging the at least one transducer includes placing the at least one transducer within the volume of the batch contaminated resource.

21 The method of claim 15 wherein the step of
introducing at least one oxidizing agent into the batch contaminated resource comprises placing an impermeable material adjacent to at least part of the batch contaminated resource boundry through which the oxidizing agent is introduced.

22. The method of claim 21 wherein the step of
introducing at least one oxidizing agent into the batch contaminated resource further comprises placing a semipermeable material between the impermeable material and the at least part of the batch contaminated resource boundry.

23. An apparatus for treating a batch contaminated resource comprising:
at least one transducer in a transducer housing and a container having an inside and outside wherein the transducer housing is in inside the container; and
an energy source coupled to the at least one transducer for energizing the at least one transducer for producing ultrasonic pressure waves in the batch contaminated resource.

24. The apparatus of claim 23 wherein
the transducer housing further comprises a body having a body first open end and a body second open end;
a top adaptively coupled to the body first open end, and
a bottom adaptively coupled to the body second open end.

25. The apparatus of claim 23 wherein
At least one transducer housing is coupled a transducer shaft for varying position the at least one transducer within the container.

26. The apparatus of claim 23 wherein
the container comprises a cylinder having an open end and a cap for coupling to the open end.

27. The apparatus of claim 26 wherein
The cap includes a cap opening sufficient to allow the transducer shaft to pass; and a sealing device for producing a liquid resistant seal.

28. The apparatus of claim 27 wherein
The sealing device is a stopper can produce the liquid resistant seal between the transducer shaft and the sealing device and between the cap and the cylinder.

29. The apparatus of claim 23 further comprising
an oxidizing agent introducing device to introduce an oxidizing agent as a solution.

30. The apparatus of claim 29 wherein the
the oxidizing agent introducing device comprises an impermeable material and inlets.

31. The apparatus of claim 29 wherein
the oxidizing agent introducing device comprises an impermeable material and inlets and
a semipermeable material between at least part of a batch contaminated resource boundary and the impermeable material.

32. The apparatus of claim 29 further comprising
a pressure reducing device to remove the solution after treatment.

33. The apparatus of claim 32 wherein
the pressure reducing device is a pump.

34. A method of treating a batch contaminated resource comprising the steps of:
adding at least one binding agent to the batch contaminated resource;
introducing at least one oxidizing agent into the added batch contaminated resource; and
energizing the added batch contaminated resource and the at least one oxidizing agent with an ultrasonic pressure wave.

35. The method of claim 34 wherein
the ultrasonic pressure wave for energizing the added batch contaminated resource and the at least one oxidizing agent comprises at least one transducer.

36. The method of claim 34 wherein
the at least one oxidizing agent is introduced as a solution to the added batch contaminated resource.

37. The method of claim 36 wherein
the solution is an aqueous solution.

38. The method of claim 36 wherein
the solution permeates the added batch contaminated resource.

39. The method of claim 38 wherein
The solution flows through the added batch contaminated resource.

40. The method of claim 34 further comprising
removing the at least one oxidizing agent from the added batch contaminated resource after treatment.

41. The method of claim 40 wherein
the at least one oxidizing agent is introduced as a solution to the added batch contaminated resource and the solution is removed after treatment.

42. The method of claim 41 wherein the solution is aqueous.

43. The method of claim 41 wherein the solution is removed using a pressure reducing device.

44. The method of claim 43 wherein the pressure reducing device is a pump.

45. The method of claim 34 wherein the at least one oxidizing agent is selected from the group consisting of: ozone, hydrogen peroxide, and combinations thereof.

46. The method of claim 35 wherein the added batch contaminated resource has a boundary and wherein the step of energizing the added batch contaminated resource and the at least one oxidizing agent comprises
placing the at least one transducer adjacent to the boundary of the added batch contaminated resource.

47. The method of claim 35 wherein the added batch contaminated resource has a boundary defining a volume and wherein the step of energizing the added batch contaminated resource and the at least one oxidizing agent comprises
placing the at least one transducer within the volume of the added batch contaminated resource.

48. A method to treat a batch contaminated resource comprising the step of:
adding at least one binding agent to a batch contaminated resource;
arranging at least one transducer in the added batch contaminated resource;
introducing at least one oxidizing agent into the added batch contaminated resource; and
energizing the added batch contaminated resource and the at least one oxidizing agent;
wherein the arranged at least one transducer can produce an ultrasonic pressure wave sufficient to energize the added batch contaminated resource and the introduced at least one oxidizing agent.

49. The method of claim 48 wherein the step of
arranging the at least one transducer creates a uni-directional ultrasonic pressure wave.

50. The method of claim 48 wherein the step of
arranging the at least one transducer creates a multi-directional ultrasonic pressure wave.

51. The method of claim 48 wherein the step of
arranging the at least one transducer comprises producing a substantially uniform ultrasonic pressure wave in the added batch contaminated resource.

52. The method of claim 48 wherein the step of
arranging the at least one transducer includes placing the at least one transducer adjacent to a boundary of the added batch contaminated resource.

53. The method of claim 48 wherein the step of
arranging the at least one transducer includes placing the at least one transducer within the volume of the added batch contaminated resource.

54. The method of claim 48 wherein the step of
introducing at least one oxidizing agent into the added batch contaminated resource comprises placing an impermeable material adjacent to at least part of the added batch contaminated resource boundry through which the oxidizing agent is introduced.

55. The method of claim 54 wherein the step of
introducing at least one oxidizing agent into the added batch contaminated resource further comprises placing a semipermeable material between the impermeable material and the at least part of the added batch contaminated resource boundry.
